(19) United States
(12) Patent Application Publication
(10) Pub. No.: US 2020/0174267 A1
(43) Pub. Date: Jun. 4, 2020

(54) 3D CLUSTER AND METHOD OF CALIBRATING THE SAME

(71) Applicants: HYUNDAI MOTOR COMPANY, Seoul (KR); KIA MOTORS CORPORATION, Seoul (KR)

(72) Inventors: Seul-A Jung, Hwaseong-si (KR); Juhyuk Kim, Suwon-si (KR)

(73) Assignees: HYUNDAI MOTOR COMPANY, Seoul (KR); KIA MOTORS CORPORATION, Seoul (KR)

(21) Appl. No.: 16/596,477

(22) Filed: Oct. 8, 2019

(30) Foreign Application Priority Data
Nov. 30, 2018 (KR) 10-2018-0152383

(51) Int. Cl. G02B 27/22; H04N 13/31; H04N 13/305; H04N 13/32

(52) U.S. Cl. CPC G02B 27/2214; H04N 13/32; H04N 13/305; H04N 13/31

(57) ABSTRACT

A 3D cluster and a method of calibrating the 3D cluster are disclosed. The method of calibrating the 3D cluster, which includes a 3D display panel configured to display images for a left eye and images for a right eye of a driver, and which includes a barrier configured to divide the images for the left eye and the images for the right eye to be transmitted to each of the left eye and the right eye of the driver. The method includes graphically displaying, by a controller, a graphical element representing an arrangement state of the barrier through the 3D display panel and guiding, by the controller, the driver to change the arrangement state of the barrier through adjustment of the graphical element.

### CROSS-REFERENCE TO RELATED APPLICATION(S)

This application is based on and claims priority under 35 U.S.C. § 119 to Korean Patent Application No. 10-2018-0152383, filed on Nov. 30, 2018 in the Korean Intellectual Property Office, the disclosure of which is incorporated by reference in its entirety.

### TECHNICAL FIELD

Embodiments of the disclosure relate to a vehicle, and more particularly, to a cluster of the vehicle.

### BACKGROUND

Recently, as the demand for stereo three-dimensional (3D) content has increased, studies related to stereo 3D content targeting various applications have been actively carried out. In modeling tools such as Maya, 3D MAX, and Rhino, there are an increasing number of visualizations using stereo rendering as a way to immersively observe virtual buildings.

The stereo 3D content is a principle that allows for images to be projected corresponding to left and right visual fields using binocular cues of humans, thereby enabling a sense of a three-dimensional effect and stereopsis. Therefore, the stereo rendering may obtain images by arranging two cameras similar to human eyes in a virtual space and may induce the images to be formed on the retina of each eyeball so that a driver can sense the depth of the images.

### SUMMARY

Therefore, it is an aspect of the disclosure to manually calibrate a barrier of a 3D cluster to be suitable for a driver's position in realizing the 3D cluster of a vehicle.

Additional aspects of the disclosure are set forth in part in the description which follows and, in part, will be apparent from the description, or may be learned by practice of the disclosure.

In accordance with an aspect of the disclosure, a method is disclosed of calibrating a 3D cluster, which includes a 3D display panel configured to display images for a left eye and images for a right eye of a driver and which includes a barrier configured to divide the images for the left eye and the images for the right eye to be transmitted to each of the left eye and the right eye of the driver. The method includes: graphically displaying, by a controller, a graphical element representing an arrangement state of the barrier through the 3D display panel; and guiding, by the controller, the driver to change the arrangement state of the barrier through adjustment of the graphical element.

The graphical element may be displayed to indicate an error between a first setting value of the barrier suitable for a current binocular position of the driver and a second setting value representing a current arrangement state of the barrier.

The graphical element may include a first object representing the first setting value of the barrier and a second object representing the second setting value of the barrier. A distance between the first object and the second object may represent the error.

The arrangement of the barrier may be changed in response to the driver moving at least one of the first object and the second object of the graphical element, thereby reducing the error.

At least one of the first object and the second object of the graphical element may be provided to move on a graphic of the 3D display panel in response to operation of at least one button of a user interface.

The method may further include graphically displaying, by the controller, a guide message for guiding the arrangement states of the barrier to be changed through adjustment of the graphical element on the 3D display panel together with the graphical element.

The method may further include storing, by the controller, a setting value of a new arrangement state of the barrier changed by the driver.

The method may further include storing, by the controller, a setting value of a new arrangement state of the barrier in association with a current memory seat setting value of a driver's seat.

In accordance with another aspect of the disclosure, a 3D cluster includes: a 3D display panel configured to display images for a left eye and images for a right eye of a driver; a barrier configured to divide the images for the left eye and the images for the right eye to be transmitted to each of the left eye and the right eye of the driver; and a controller configured to graphically display a graphical element representing an arrangement state of the barrier through the 3D display panel and to guide the driver to change the arrangement state of the barrier through adjustment of the graphical element.

The graphical element may be displayed to indicate an error between a first setting value of the barrier suitable for a current binocular position of the driver and a second setting value representing a current arrangement state of the barrier.

The graphical element may include a first object representing the first setting value of the barrier and a second object representing the second setting value of the barrier. A distance between the first object and the second object may represent the error.

The arrangement of the barrier may be changed in response to the driver moving at least one of the first object and the second object of the graphical element, thereby reducing the error.

At least one of the first object and the second object of the graphical element may be provided to move on a graphic of the 3D display panel in response to operation of at least one button of a user interface.

The controller may graphically display a guide message for guiding the arrangement states of the barrier to be changed through adjustment of the graphical element on the 3D display panel together with the graphical element.

The controller may store a setting value of a new arrangement state of the barrier changed by the driver.

The controller may store a setting value of a new arrangement state of the barrier in association with a current memory seat setting value of a driver's seat.

In accordance with another aspect of the disclosure, a method is disclosed of calibrating a 3D cluster, which includes a 3D display panel configured to display images for a left eye and images for a right eye of a driver and which includes a barrier configured to divide the images for the left eye and the images for the right eye to be transmitted to each of the left eye and the right eye of the driver. The method includes: graphically displaying, by a controller, through the 3D display panel, a graphical element representing an error between a first setting value of the barrier suitable for a current binocular position of the driver and a second setting value representing a current arrangement state of the barrier; guiding, by the controller, the driver to change the arrangement state of the barrier through adjustment of the graphical element; storing, by the controller, a setting value of a new arrangement state of the barrier changed by the driver; and storing, by the controller, the setting value of the new arrangement state of the barrier in association with a current memory seat setting value of a driver's seat.

The graphical element may include a first object representing the first setting value of the barrier and a second object representing the second setting value of the barrier. A distance between the first object and the second object may represent the error.

The arrangement of the barrier may be changed in response to the driver moving at least one of the first object and the second object of the graphical element, thereby reducing the error.

At least one of the first object and the second object of the graphical element may be provided to move on a graphic of the 3D display panel in response to operation of at least one button of a user interface.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a control system of a vehicle according to embodiments of the disclosure;

FIG. 2 is a view illustrating a method of controlling a 3D cluster of a vehicle according to embodiments of the disclosure;

FIG. 3 is a view illustrating an implementation of 3D graphics of a 3D cluster according to embodiments of the disclosure;

FIGS. 4A and 4B are views illustrating a relationship between a binocular distance between the eyes of a user and an arrangement of a barrier, respectively;

FIG. 5 is a view illustrating a method of manually calibrating a 3D display panel of a vehicle according to embodiments of the disclosure;

FIGS. 6A-6D are views illustrating manual calibration selection screens of a 3D cluster of a vehicle according to embodiments of the disclosure;

FIG. 7 is a start screen for guiding a manual calibration of a 3D cluster of a vehicle according to embodiments of the disclosure;

FIG. 8 is a view illustrating a guidance screen for substantially calibrating a barrier of a 3D cluster of a vehicle according to embodiments of the disclosure;

FIG. 9 is a view illustrating a state in which a red ball is matched (overlapped) with a blue ball by a driver's operation; and

FIG. 10 is a view illustrating a method of controlling interlocking of barrier settings between a driver's seat memory seat and a 3D display panel according to embodiments of the disclosure.

### DETAILED DESCRIPTION

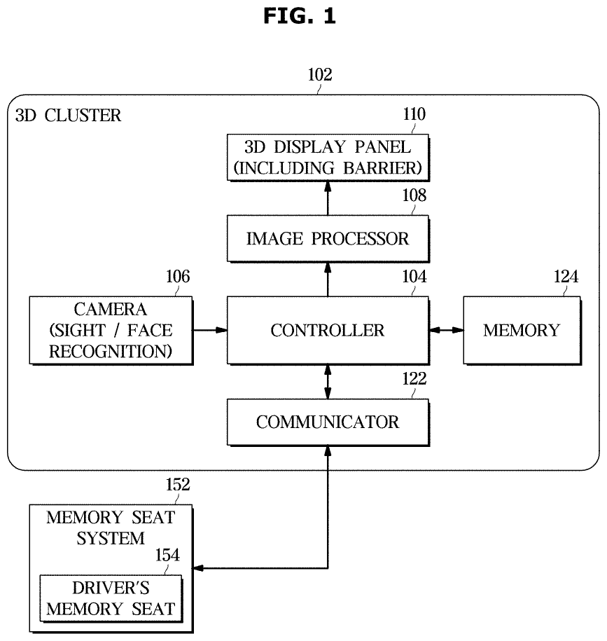

FIG. 1 is a view illustrating a control system of a vehicle according to embodiments of the disclosure.

FIG. 1 illustrates a memory seat system 152 that is communicatively coupled to a 3D cluster 102 with a configuration of the 3D cluster 102. The configuration of the 3D cluster 102 is as follows.

A controller 104 may be an electronic control unit (ECU) that controls the overall operation of the 3D cluster 102. The controller 104 may implement 3D graphics in the 3D cluster 102 by controlling the arrangement of barriers of a 3D display panel 110 to determine a binocular position of a driver and to be suitable for the determined binocular position of the driver.

A camera 106 may be provided to recognize the driver's sight/face.

Through the sight/face recognition of the camera 106, the controller 104 may obtain information about the binocular position of the driver. The 3D graphics of the 3D cluster 102 may be provided to the driver so that it is possible to provide the 3D graphics of higher quality as the binocular position of the driver is accurately detected.

An image processor 108 may perform data processing of an image of the driver's face through the camera 106. The image processor 108 may implement the 3D graphics optimized for the driver's sight based on a processing result of image data.

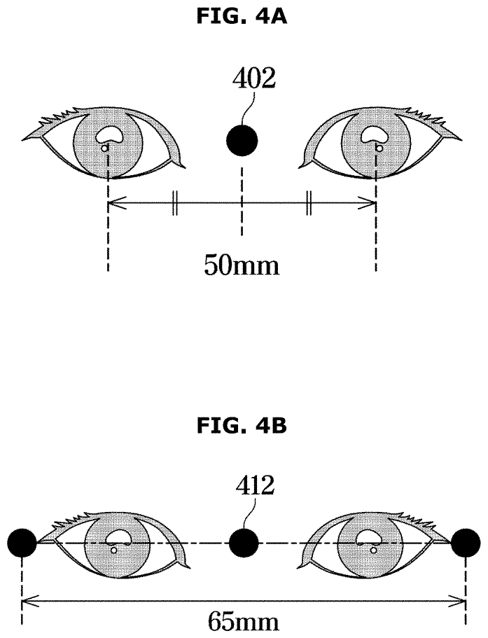

The 3D display panel (including the barrier) 110 may be provided to implement the 3D graphics based on the driver's sight/face recognition result. The 3D graphics implemented through the 3D display panel 110 include information to be displayed to the driver through the 3D cluster 102 in a vehicle. The barrier is a device for implementing the 3D graphics suitable for the driver's sight by changing the arrangement according to the binocular position of the driver. The role of the barrier is described in detail in the description of FIGS. 4A and 4B below.

A communicator 122 may be provided so that the controller 104 of the 3D cluster 102 can communicate with the memory seat system 152 of a driver's seat. The binocular position of the driver may vary depending on the position of the driver's seat. Thus, the controller 104 of the 3D cluster 102 may communicate with the memory seat system 152 to determine a setting state of a driver's memory seat 154 and to reflect the setting state of the driver's memory seat 154 in the 3D graphics implementation of the 3D cluster 102 so that optimal 3D graphics can be implemented in the 3D cluster 102.

A memory 124 may store arrangement information of the barrier of the 3D display panel 110 corresponding to the setting state of the driver's memory seat 154.

The memory seat system 152 may store an optimal driver's seat position for the driver and automatically adjust the position of the driver's seat according to a setting value of the driver's memory seat 154 stored in the memory seat system 152 when the driver is on board, i.e., seated in the vehicle.

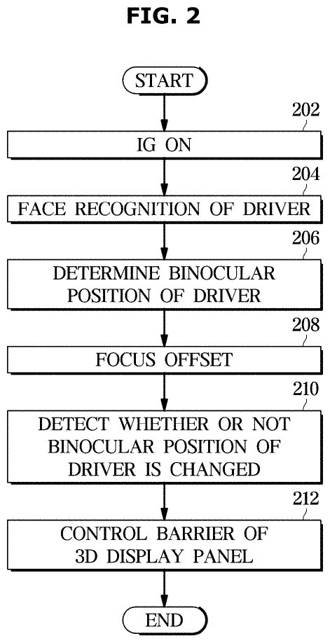

FIG. 2 is a view illustrating a method of controlling a 3D cluster of a vehicle according to embodiments of the disclosure. As illustrated in FIG. 2, when the driver is on the driver's seat and starts an engine, i.e., ignition (IG) ON (202), the controller 104 of the 3D cluster 102 may operate the camera 106 to capture the driver and recognize the driver's face (204).

The controller 104 may determine the binocular position of the driver from the face recognition result of the driver (206).

The controller 104 may also offset a focus based on the binocular position of the driver (208). A focal length corresponds to a distance between a binocular central point 402 of the driver (see FIG. 4) and the 3D display panel 110. Since the position of the binocular central point of the driver is not always located at the front of the 3D display panel 110, it is necessary to determine the offset of the binocular central point of the driver from the front of the 3D display panel 110.

In this state, the controller 104 may continuously monitor the camera 106 as to whether the binocular position of the driver is changed (210). When the driver moves away from the front of the 3D display panel 110 by moving his/her body while sitting on the driver's seat (offset >0), the controller 104 may variably control the arrangement of the barrier of the 3D display panel 110 by reflecting the magnitude of the offset (212). Through the variable control of the barrier of the 3D display panel 110, the controller 104 may always provide the optimized 3D graphics to the driver.

In this manner, the controller 104 may continue to track the binocular position of the driver through the camera 106 while the driver is driving the vehicle. The controller 104 may continuously control the arrangement of the barrier of the 3D display panel 110 by reflecting the changing binocular position of the driver.

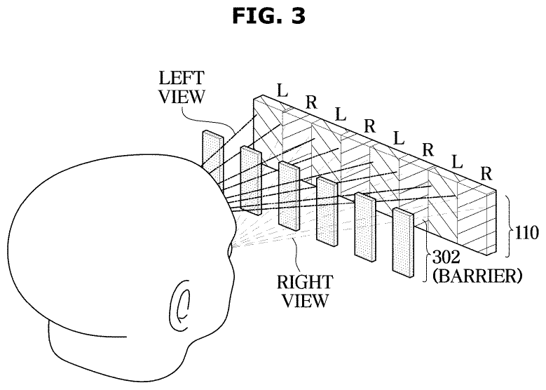

FIG. 3 is a view illustrating an implementation of 3D graphics of a 3D cluster according to embodiments of the disclosure.

The 3D cluster 102 may implement the 3D graphics of the clusters of the vehicle so as to exhibit a three-dimensional effect. As illustrated in FIG. 3, the 3D graphic is a graphic representation technique that allows a user to feel the three-dimensional effect while synthesizing two images into a single image in the user's brain by displaying images L for a left eye and images R for a right eye in each of the left eye and the right eye of the user.

To this end, the single image is divided into the images L for the left eye and the images R for the right eye so that the images L for the left eye are input only to the left eye of the user through a barrier 302 and the images R for the right eye are input only to the right eye of the user through the barrier 302. Thus, the variable control of the arrangement of the barriers 302 due to the change of the binocular position of the user is a very important factor for realizing the optimal 3D graphics matching the binocular position of the user.

FIGS. 4A and 4B are views illustrating a relationship between a binocular distance between the eyes of a user and an arrangement of a barrier, respectively.

In general, the barrier arrangement of the 3D display panel is designed assuming that the distance between the left eye and the right eye is 65 mm. FIG. 4A illustrates a case where the binocular distance between the user's eyes is 50 mm. As illustrated in FIG. 4B, when the binocular distance between the user's eyes is assumed to be 65 mm and the offset relative to a central point 412 is set, even though the binocular distance of the driver is actually 50 mm as illustrated in FIG. 4A, the arrangement of the barrier 302 of the 3D display panel 110 does not reflect the actual binocular distance of the driver, resulting in a crosstalk phenomenon. The crosstalk phenomenon is a phenomenon in which the images L for the left eye can be seen in the right eye or the images R for the right eye can be seen in the left eye because the barrier 302 cannot accurately determine the images L for the left eye and the images R for the right eye. When the crosstalk phenomenon occurs, the image is not clearly seen by the drivers eyes.

As described above, when the basic arrangement state of the barrier 302 of the 3D display panel 110 does not match the binocular position of the driver, the crosstalk phenomenon will continuously occur. Therefore, in the vehicle according to embodiments, the driver may manually calibrate the arrangement state of the barrier 302 of the 3D display panel 110 to match the binocular position of the driver so that the optimal 3D graphics can be implemented in the 3D cluster 102.

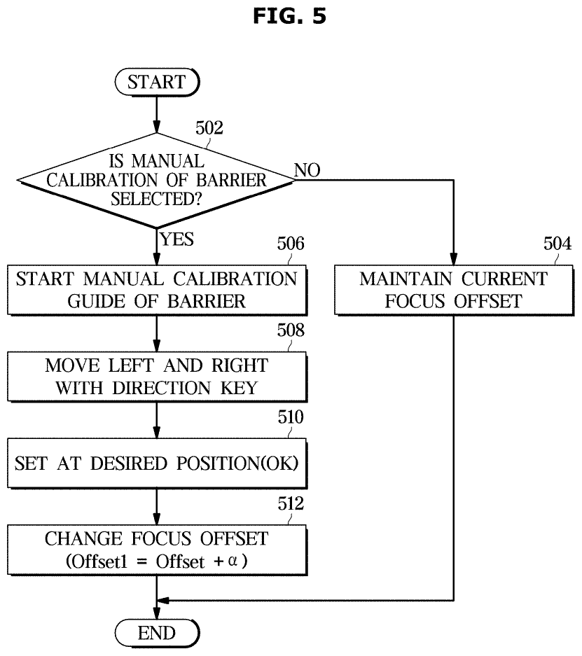

FIG. 5 is a view illustrating a method of manually calibrating a 3D display panel of a vehicle according to embodiments of the disclosure. As illustrated in FIG. 5, the driver may select manual calibration of the barrier 302 of the 3D display panel 110 through a user interface for optimization of the 3D graphics when it is determined that the 3D graphics of the 3D cluster 102 is not optimized for the driver himself (502).

When the driver does not select the manual calibration of the 3D cluster 102 (NO in 502) because the driver is satisfied with the 3D graphics quality of the 3D cluster 102, the controller 104 may still maintain the current focus offset of the current 3D cluster 102 (504).

Conversely, when the driver selects the manual calibration of the 3D cluster 102 (YES in 502) because the driver is not satisfied with the 3D graphics quality of the 3D cluster 102, the controller 104 may start a guide for the manual calibration of the 3D cluster 102 (506).

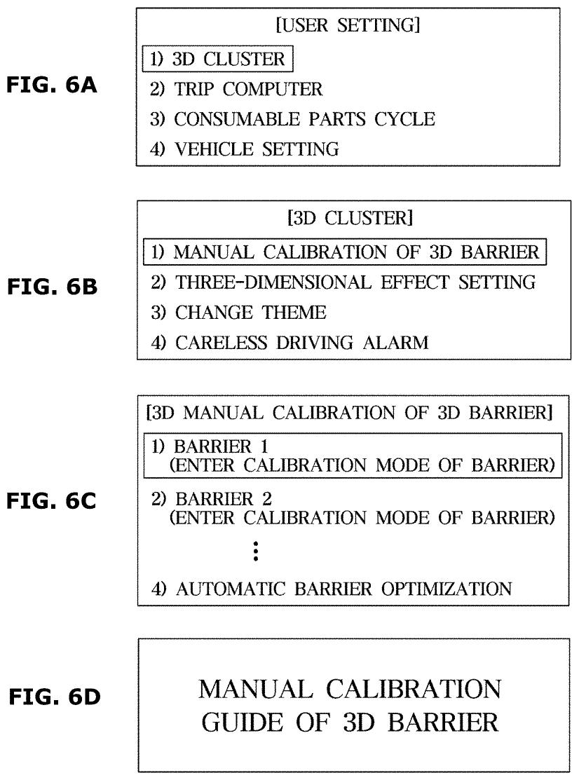

To this end, the 3D display panel 110 may display screens as illustrated in FIGS. 6A-6D. FIGS. 6A-6D are views illustrating manual calibration selection screens of a 3D cluster of a vehicle according to embodiments of the disclosure. The manual calibration of the 3D cluster 102 of the vehicle according to embodiments of the disclosure is performed by selecting a calibration mode of the 3D cluster 102 in the order of FIGS. 6A to 6C. When the selection of the calibration mode of the 3D cluster 102 is completed, a guide screen for the manual calibration of the barrier 302 as illustrated in FIG. 6D may be displayed.

First, as illustrated in FIG. 6A, ‘3D cluster’ is selected in a first menu [user setting menu]. Next, as illustrated in FIG. 6B, in a second menu [3D cluster menu], ‘manual calibration of 3D barrier’ is selected. Subsequently, as illustrated in FIG. 6C, “Barrier 1 (entering barrier calibration mode”) is selected in a third menu [3D barrier manual calibration menu]. In FIG. 6C, the reason why the barrier 302 such as the ‘Barrier 1’ and ‘Barrier 2’ is divided into a plurality is that the driver can set the inherent barrier for a plurality of the drivers in consideration of the binocular position for each of the drivers when the plurality of drivers share the vehicle.

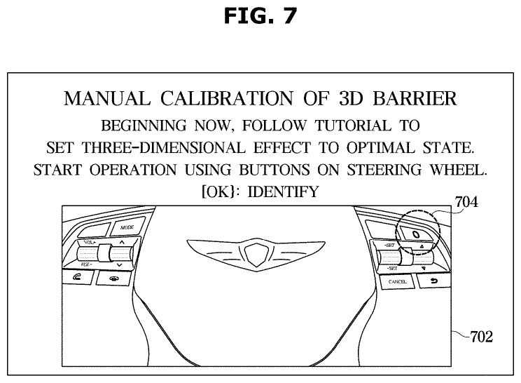

The manual calibration of the 3D cluster 102 may be made by the driver performing necessary operations as required on the guide screen displayed on the 3D display panel 110 of the 3D cluster 102. To this end, a start screen as illustrated in FIG. 7 may be displayed on the 3D display panel 110. FIG. 7 is a start screen for guiding a manual calibration of a 3D cluster of a vehicle according to embodiments of the disclosure. As illustrated in FIG. 7, an image of a steering wheel 702 of the vehicle may be displayed on the 3D display panel 110. A guide speech, such as “Beginning now, follow the tutorial to set the three-dimensional effect to the optimal state. Start the operation using buttons on the steering wheel.” may be displayed together on the 3D display panel 110. The driver may start the manual calibration of the 3D cluster 102 by pressing an OK button 704 provided on the actual steering wheel.

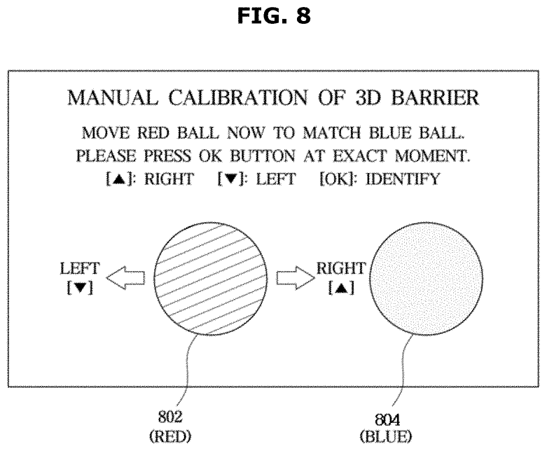

Then, the guide screen as illustrated in FIG. 8 may be displayed on the 3D display panel 110. FIG. 8 is a view illustrating a guidance screen for substantially calibrating a barrier of a 3D cluster of a vehicle according to embodiments of the disclosure. As illustrated in FIG. 8, a red ball 802 and a blue ball 804 may be displayed on the 3D display panel 110. The guide speech, such as “Move the red ball now to match the blue ball. Please press the OK button at the exact moment.”

may be displayed together on the 3D display panel 110.

Returning to FIG. 5, in response to the guide speech, the driver may move the red ball 802 on the screen to the left and right by using a predetermined direction key to match the red ball 802 on the screen with the blue ball 804 (508). Here, the predetermined direction key may be a direction key provided on a steering wheel 702. When the steering wheel 702 is not provided with left and right direction keys, the red ball 802 may be moved to the left and right using upward and downward keys instead. For example, the upward direction key may be used as the left direction key and the downward direction key may be used as the right direction key.

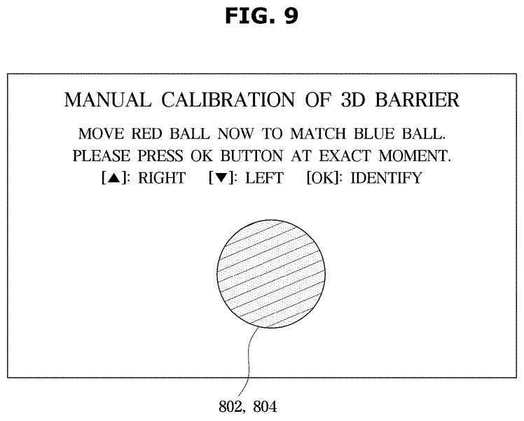

When the driver moves the red ball 802 to the left and right using the predetermined direction keys and presses the OK button 704 at a desired position, i.e., a position 906 (see FIG. 9) where the red ball 802 matches the blue ball 804, the calibration of the barrier 302 of the 3D cluster 102 is completed (510). FIG. 9 is a view illustrating a state in which a red ball is matched (overlapped) with a blue ball by a driver's operation.

The spacing between the red ball 802 and the blue ball 804 illustrated in FIG. 8 may refer to a relative arrangement of the barrier 302 relative to the binocular position of the driver. When the distance to the binocular position of the driver and the 3D cluster 102 is more than or less than a default design value, the spacing between the red ball 802 and the blue ball 804 may also increase or decrease from the default design value. In other words, the distance between the red ball 802 and the blue ball 804 in FIG. 8 is proportional to the distance to the binocular position of the driver and the 3D cluster 102. When the driver moves the red ball 802 of FIG. 8 such that the red ball 802 matches (overlaps) the blue ball 804, the controller 104 may adjust the arrangement of the barrier 302 by a value proportional to the distance moved until the red ball 802 matches the blue ball 804 so that the barrier 302 of the 3D display panel 110 has the arrangement that matches the distance to the binocular position of the driver and the 3D cluster 102.

Returning to FIG. 3, when the manual calibration of the barrier 302 of the 3D display panel 110 is completed, the controller 104 may change the focus offset as much as the arrangement of the barrier 302 is adjusted to be variable and store the changed focus offset in the memory 124 as a new value (offset1=offset+α) (512).

Through this series of processes, the manual calibration of the 3D cluster 102 of the vehicle may be completed.

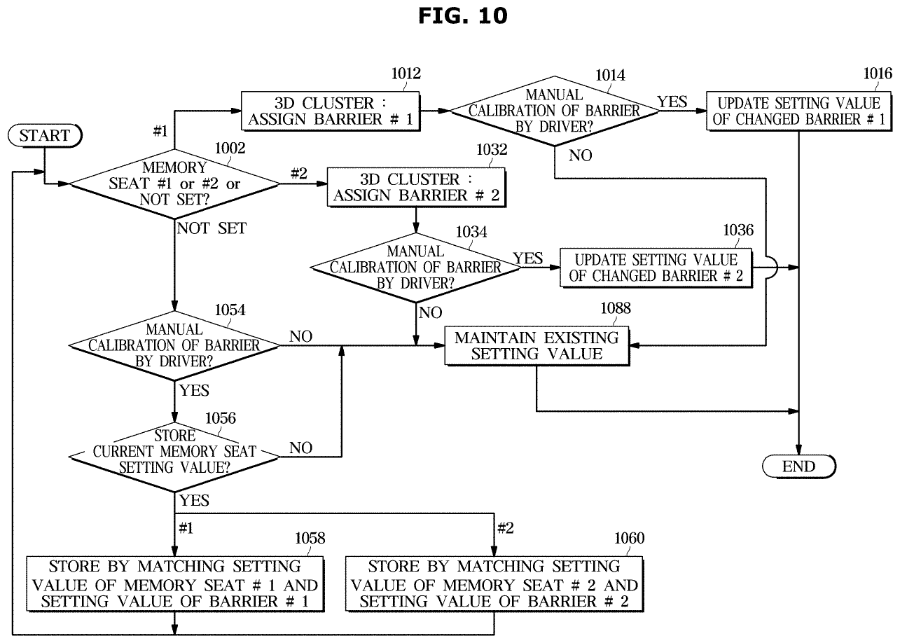

FIG. 10 is a view illustrating a method of controlling interlocking of barrier settings between a driver's memory seat and a 3D display panel according to embodiments of the disclosure. The control method of FIG. 10 assumes that the setting of the driver's memory seat 154 is capable of setting two or more of a ‘memory seat 1’ and a ‘memory seat 2’. The setting of the barrier 302 of the 3D cluster 102 is also capable of setting two or more of the ‘memory seat 1’ and the ‘memory seat 2’. The control method of FIG. 10 interlocks the setting of the driver's memory seat 154 and setting of the barrier 302 of the 3D display panel 110. The control method is to provide optimized graphics quality of the 3D cluster 102 for each of the plurality of drivers by changing the setting of the barrier 302 of the 3D display panel 110 in response to the selection of the driver's memory seat 154 for each of the drivers.

As illustrated in FIG. 10, the controller 104 may identify the setting state of the driver's memory seat 154 stored in the memory seat system 152 through communication with the memory seat system 152 (1002). When the setting value of a ‘memory seat #1’ exists, the controller 104 may proceed to ‘#1’ of operation 1002. When the setting value of a ‘memory seat #2’ exists, the controller 104 may proceed to ‘#2’ of operation 1002. When the setting value does not exist, the controller 104 may proceed to ‘not set’ of operation 1002.

When there is the setting value of the memory seat #1 (‘#1’ in 1002), the controller 104 may assign a barrier #1 of the 3D cluster 102 to the memory seat #1 and interlock them with each other (1012). The ‘barrier #1’ of the 3D cluster 102 is for distinguishing the setting value of the barrier 302 for each of the drivers and is not for physically distinguishing the barrier 302 of the 3D display panel 110.

When the barrier #1 is assigned to the memory seat #1 and the corresponding driver of the memory seat #1 (distinguished by a driver #1 for convenience) manually calibrates the barrier 302 to be optimized for the driver #1 himself/herself (YES in 1014), the controller 104 may update the memory 124 by matching the setting value changed by manual calibration of the barrier 302 to the memory seat #1 (1016). In other words, when the setting value of the barrier #1 is changed by the manual calibration of the driver #1 in the state where the memory seat #1 and the barrier #1 are matched with each other, the controller 104 may replace the setting value of the existing barrier #1 with the setting value of a new barrier #1 changed by the manual calibration of the driver #1.

Conversely, when the barrier #1 is assigned to the memory seat #1, and the driver #1 of the memory seat #1 does not manually calibrate the barrier 302 (NO in 1014), the controller 104 may maintain the setting values of the memory seat #1 and the barrier #1 stored in the memory as the existing setting values (1088).

Returning to operation 1012, when there is the setting value of the memory seat #2 (‘#2’ in 1002), the controller 104 may assign a barrier #2 of the 3D cluster 102 to the memory seat #2 and interlock them with each other (1032). The ‘barrier #2’ of the 3D cluster 102 is for distinguishing the setting value of the barrier 302 for each of the drivers and is not for physically distinguishing the barrier 302 of the 3D display panel 110.

When the barrier #2 is assigned to the memory seat #2, and the corresponding driver of the memory seat #2 (distinguished by a driver #2 for convenience) manually calibrates the barrier 302 to be optimized for the driver #2 himself/herself (YES in 1034), the controller 104 may update the memory 124 by matching the setting value changed by manual calibration of the barrier 302 to the memory seat #2 (1036). In other words, when the setting value of the barrier #2 is changed by the manual calibration of the driver #2 in the state where the memory seat #2 and the barrier #2 are matched with each other, the controller 104 may replace the setting value of the existing barrier #2 with the setting value of a new barrier #2 changed by the manual calibration of the driver #2.

Conversely, when the barrier #2 is assigned to the memory seat #2, and the driver #2 of the memory seat #2 does not manually calibrate the barrier 302 (NO in 1034), the controller 104 may maintain the setting values of the memory seat #2 and the barrier #2 stored in the memory as the existing setting values (1088).

Returning to operation 1012, when there is no setting value of the memory seat (NOT SET in 1002), the controller 104 may identify that the driver manually calibrates the barrier 302 to be optimized for the driver himself/herself (1054).

When the driver manually calibrates the barrier 302 to be optimized for the driver himself/herself (YES in 1054), the controller 104 may identify to the driver whether to store the current memory seat setting value. The identification of whether or not the memory seat setting value is stored may be output by an identification message on the 3D cluster 102, and identify it through a response input of the driver.

When the driver wishes to store the current memory seat setting value (YES in 1056), the controller 104 may store the current memory seat setting value in the memory seat system 152 as the setting value of the ‘memory seat #1’. The controller 104 may also match the setting value of the memory seat #1 and the current setting value of the barrier 302 (for example, barrier #1) and store it in the memory 124 (1058). Alternatively, when the driver wishes to store the current memory seat setting value (YES in 1056), the controller 104 may store the current memory seat setting value in the memory seat system 152 as the setting value of the ‘memory seat #2’. The controller 104 may also match the setting value of the memory seat #2 and the current setting value of the barrier 302 (for example, barrier #2) and store it in the memory 124 (1060).

Conversely, when the driver does not manually calibrate the barrier 302 (NO in 1054) or does not wish to store the current memory seat setting value (NO in 1056), the controller 104 may maintain the existing barrier setting value stored in the memory (1088).

As is apparent from the above description, applying embodiments of the disclosure, the barrier of the 3D cluster can be manually calibrated to be suitable for the driver's position in realizing the 3D cluster of the vehicle.

The above description of the present disclosure is for illustrative purposes. A person having ordinary skill in the art should appreciate that other specific modifications may be easily made without departing from the technical spirit or essential features of the present disclosure. Therefore, the above embodiments should be regarded as illustrative rather than limitative in all aspects. The scope of the disclosure is not to be limited by the detailed description set forth above, but by the accompanying claims of the present disclosure. It should also be understood that all changes or modifications derived from the definitions and scope of the claims and their equivalents fall within the scope of the present disclosure.

What is claimed is:

1. A method of calibrating a 3D cluster, which comprises a 3D display panel configured to display images for a left eye and images for a right eye of a driver, and which further comprises a barrier configured to divide the images for the left eye and the images for the right eye to be transmitted to each of the left eye and the right eye of the driver, the method comprising:
graphically displaying, by a controller, a graphical element representing an arrangement state of the barrier through the 3D display panel; and
guiding, by the controller, the driver to change the arrangement state of the barrier through adjustment of the graphical element.

2. The method according to claim 1, wherein the graphical element is displayed to indicate an error between a first setting value of the barrier suitable for a current binocular position of the driver and a second setting value representing a current arrangement state of the barrier.

3. The method according to claim 2, wherein the graphical element comprises a first object representing the first setting value of the barrier and a second object representing the second setting value of the barrier, and
wherein a distance between the first object and the second object represents the error.

4. The method according to claim 3, wherein the arrangement of the barrier is changed in response to the driver moving at least one of the first object and the second object of the graphical element, thereby reducing the error.

5. The method according to claim 4, wherein at least one of the first object and the second object of the graphical element is provided to move on a graphic of the 3D display panel in response to operation of at least one button of a user interface.

6. The method according to claim 1, further comprising:
graphically displaying, by the controller, a guide message for guiding the arrangement states of the barrier to be changed through adjustment of the graphical element on the 3D display panel together with the graphical element.

7. The method according to claim 1, further comprising:
storing, by the controller, a setting value of a new arrangement state of the barrier changed by the driver.

8. The method according to claim 1, further comprising:
storing, by the controller, a setting value of a new arrangement state of the barrier in association with a current memory seat setting value of a driver's seat.

9. A 3D cluster comprising:
a 3D display panel configured to display images for a left eye and images for a right eye of a driver;
a barrier configured to divide the images for the left eye and the images for the right eye to be transmitted to each of the left eye and the right eye of the driver; and
a controller configured to graphically display a graphical element representing an arrangement state of the barrier through the 3D display panel, and configured to guide the driver to change the arrangement state of the barrier through adjustment of the graphical element.

10. The 3D cluster according to claim 9, wherein the graphical element is displayed to indicate an error between a first setting value of the barrier suitable for a current binocular position of the driver and a second setting value representing a current arrangement state of the barrier.

11. The 3D cluster according to claim 10, wherein the graphical element comprises a first object representing the first setting value of the barrier and a second object representing the second setting value of the barrier, and
wherein a distance between the first object and the second object represents the error.

12. The 3D cluster according to claim 11, wherein the arrangement of the barrier is changed in response to the driver moving at least one of the first object and the second object of the graphical element, thereby reducing the error.

13. The 3D cluster according to claim 12, wherein at least one of the first object and the second object of the graphical element is provided to move on a graphic of the 3D display panel in response to operation of at least one button of a user interface.

14. The 3D cluster according to claim 9, wherein the controller is configured to graphically display a guide message for guiding the arrangement states of the barrier to be changed through adjustment of the graphical element through on the 3D display panel together with the graphical element.

15. The 3D cluster according to claim 9, wherein the controller is configured to store a setting value of a new arrangement state of the barrier changed by the driver.

16. The 3D cluster according to claim 9, wherein the controller is configured to store a setting value of a new arrangement state of the barrier in association with a current memory seat setting value of a driver's seat.

17. A method of calibrating a 3D cluster, which comprises a 3D display panel configured to display images for a left eye and images for a right eye of a driver, and which further comprises a barrier configured to divide the images for the left eye and the images for the right eye to be transmitted to each of the left eye and the right eye of the driver, the method comprising:
graphically displaying, by a controller, through the 3D display panel, a graphical element representing an error between a first setting value of the barrier suitable for a current binocular position of the driver and a second setting value representing a current arrangement state of the barrier;
guiding, by the controller, the driver to change the arrangement state of the barrier through adjustment of the graphical element;
storing, by the controller, a setting value of a new arrangement state of the barrier changed by the driver; and
storing, by the controller, the setting value of the new arrangement state of the barrier in association with a current memory seat setting value of a driver's seat.

18. The method according to claim 17, wherein the graphical element comprises a first object representing the first setting value of the barrier and a second object representing the second setting value of the barrier, and
wherein a distance between the first object and the second object represents the error.

19. The method according to claim 18, wherein the arrangement of the barrier is changed in response to the driver moving at least one of the first object and the second object of the graphical element, thereby reducing the error.

20. The method according to claim 19, wherein at least one of the first object and the second object of the graphical element is provided to move on a graphic of the 3D display panel in response to operation of at least one button of a user interface.
